(19) United States
(12) Patent Application Publication
(10) Pub. No.: US 2025/0117191 A1
(43) Pub. Date: Apr. 10, 2025

(54) PATCH GENERATION METHOD, PATCH GENERATION APPARATUS AND PROGRAM

(71) Applicant: NIPPON TELEGRAPH AND TELEPHONE CORPORATION, Tokyo (JP)

(72) Inventor: Daisuke YAMAGUCHI, Tokyo (JP)

(21) Appl. No.: 18/725,968

(22) PCT Filed: Feb. 1, 2022
(86) PCT No.: PCT/JP2022/003899

§ 371 Date: Jul. 1, 2024

(51) Int. Cl. G06F 8/30

(52) U.S. Cl. CPC G06F 8/30

(57) ABSTRACT

A computer executes an input procedure of inputting a patch including an operator not defined in SmPL and having a variable name id for which a default value is specified, a type T of id, and an id default value t as arguments, and a description using SmPL, and a rewrite target program, and a generation procedure of generating a patch indicating, by using SmPL, that a variable declaration statement for substituting a computation result of t into the T-type variable id is added to the rewrite target program when the T-type variable is not defined in the rewrite target program, and generating a patch in which id in the description is replaced with the variable when the T-type variable is defined in the rewrite target program, thereby improving efficiency related to rewriting of a program.

### TECHNICAL FIELD

The present invention relates to a patch generation method, a patch generation apparatus, and a program.

### BACKGROUND ART

In software development, the same editing is often performed on a plurality of locations in a program. A program rewriting tool typified by a patch enables automatic rewriting for a plurality of locations in such a program.

When the program rewriting tool receives, as inputs, a rewrite target program and a script that defines content of editing and characterization of lines, commands, and expressions in the program to which the editing is to be applied, the program rewriting tool applies the editing content defined in the script to a location in the rewrite target program matching the characterization defined in the script. For example, a script in the case of a patch is given in a diff format. In this case, the editing content is defined by specification of deletion/addition in units of lines, and a location to which editing is applied is characterized by specification of a character string. The editing is applied to a line matching the specified character string among the lines in the rewrite target program.

The patch is widely used not only for programs but also for rewriting general text files because characterization of a location to which editing of the editing content is applied can be defined by an intuitive description in a diff format. However, specification of editing content is limited to the line unit, and characterization of an application location is limited to matching with a specific character string. These restrictions may be particularly a restriction in by using the patch to rewrite a program. For example, a location to which rewriting is applied needs to exactly match a specified character string, and in a case where only a variable name is different from the character string even in the same command, rewriting is not applied. In a method based on the entire list, it is possible to write definitions corresponding to all patterns of variable names that may exist in a diff format, but it is not a realistic method.

From the above, there is a need for a program rewriting tool that enables specification of a more flexible and powerful editing content and characterization of an application location than a patch while also achieving intuitive descriptive properties.

### [Program Rewriting Tool Based on Program Matching by Using Control Flow]

In order to enable specification of flexible and powerful editing content and characterization of an editing application location in rewriting of a program, a method of matching a code piece in a rewrite target program and an editing application location with each other after returning to a model check problem regarding a control flow of the rewrite target program has been proposed (Non Patent Literature 1).

Coccinelle is a well-known program rewriting tool based on this technology. Specifically, there are Coccinelle (Non Patent Literature 4) for rewriting the C program and Coccinelle 4J (Non Patent Literature 3) for rewriting the Java (registered trademark) program. Hereinafter, these will be collectively referred to as Coccinelle.

Coccinelle is a popular program rewriting tool and is often used by developers of the Linux (registered trademark) kernel driver and developers of some other famous applications (for example, Wine (https://wiki.winehq.org/Static_Analysis#Coccinelle) or Zephyr (https://docs.zephyrproject.org/latest/guides/coccinelle.html)). Hereinafter, Coccinelle will be described as a representative tool of the program rewriting tool based on the technique in Non Patent Literature 1.

Coccinelle characterizes editing content and editing application locations by a domain-specific language (DSL) called a semantic patch (SmPL) based on the technique in Non Patent Literature 1. The editing content is specified by annotating + and − at the head of each code piece to add and erase the code piece similarly to that in diff. In this case, the unit of the code piece does not necessarily need to be a row unit, and can be specified in any syntax unit. The following characteristic functions can be used in SmPL.

### <I. Meta-Variable>

In Coccinelle, a meta-variable representing a formula or a type of a program may be used to specify editing content and an editing application location. By using the meta-variable, a specific variable name or a name of a formula, or a type can be abstracted.

FIG. 1 is a diagram illustrating an example of SmPL by using a meta-variable v. The editing is applied to a code piece matching a code piece annotated with—among code pieces in a rewrite target program, but even if a variable name of a code piece is not v, the code piece matches SmPL in FIG. 1 as long as the code piece indicates a command in which a value obtained by new ByteRef( ) is substituted into a BytesRef type variable.

### <II. Regular-Expression-Like Operator>

In Coccinelle, an operator in a regular expression such as selection “(a|b)” or any character string “ . . . ” can be used to characterize an editing application location.

FIG. 2 is a diagram illustrating an example by using the selection operator (a|b). If there is a program piece matching sendStickyBroadcast(i) in a rewrite target program, the first half editing separated by “|” is applied, and the program piece matching sendStickyBroadcast(i) is replaced with sendBraddcast(i). Even in a case where the matching fails, if there is a program piece matching removeStickyBroadcast(i), the second half editing separated by “|” is applied, and the matching location is deleted. For details including other operators, refer to https://coccinelle.gitlabpages.inria.fr/website/docs/index.html.

These SmPL features allow Coccinelle to realize flexible characterization of an editing location and refinement of an editing unit and also to describe them intuitively.

### CITATION LIST

### Non Patent Literature

Non Patent Literature 1: Brunel, J., Doligez, D., Hansen, R. R., Lawall, J. L., and Muller, G. A foundation for flow-based program matching: Using temporal logic and model checking. In Proceedings of the 36th Annual ACM SIGPLAN-SIGACT Symposium on Principles of Programming Languages (New York, NY, USA, 2009), POPL '09, Association for Computing Machinery, p. 114-126.
Non Patent Literature 2: Jones, N. D., and Hansen, R. R. The semantics of “semantic patches” in coccinelle: Program transformation for the working programmer. In Programming Languages and Systems (Berlin, Heidelberg, 2007), Z. Shao, Ed., Springer Berlin Heidelberg, pp. 303-318.
Non Patent Literature 3: Kang, H. J., Thung, F., Lawall, J., Muller, G., Jiang, L., and Lo, D. Semantic Patches for Java Program Transformation (Experience Report). In 33rd European Conference on ObjectOriented Programming (ECOOP 2019) (Dagstuhl, Germany, 2019), A. F. Donaldson, Ed., vol. 134 of Leibniz International Proceedings in Informatics (LIPIcs), Schloss Dagstuhl-Leibniz-Zentrum fuer Informatik, pp. 22:1-22:27.
Non Patent Literature 4: Padioleau, Y., Lawall, J., Hansen, R. R., and Muller, G. Documenting and automating collateral evolutions in linux device drivers. In Proceedings of the 3rd ACM SIGOPS/EuroSys European Conference on Computer Systems 2008 (New York, NY, USA, 2008), Eurosys '08, Association for Computing Machinery, p. 247-260.

### SUMMARY OF INVENTION

### Technical Problem

### [Difficulty in Applying Patch Considering Presence or Absence of Variable Definition]

When a program is rewritten, there is a case where it is desired to change the editing content of the program depending on whether or not there is a definition of a specific variable in the rewrite target program. As an example, a case where editing defined by SmPL in FIG. 1 is applied to the rewrite target program in FIG. 3 will be considered.

The program illustrated in FIG. 3 is a fictitious program created for description. A local variable m is a variable for specifying an operation mode of BytesRef. In FIG. 3, a value Mode. Debug indicating a debug mode is substituted. When a series of codes is a program calling a constructor BytesRef( ), the meaning of the program can be read as “the operation mode of ByteRef r is specified as a debug mode by the local variable m”.

However, the program illustrated in FIG. 3 is rewritten into a program illustrated in FIG. 4 by applying the rewriting defined in FIG. 1.

In FIG. 4, although the declaration of the local variable m remains, the call of BytesRefbuilder, which is a replacement of BytesRef, is performed with the variable arg into which the operation mode Mode.Defalut is substituted, as an argument. In this case, the meaning of the code before rewriting “debug mode is specified” is ignored.

In the case of the SmPL example in FIG. 1, editing that does not ignore the meaning of the code before rewriting can be reproduced in a pseudo manner by using the selection operator. For example, a description in which whether or not a variable specifying an operation mode is declared is classified by using a selection operator as illustrated in FIG. 5 may be considered.

The first half of the branch of the selection operator is used to check whether the Mode type variable is declared in the rewrite target program, and in this case, the declaration of the Mode type variable is not included in an added new program piece. Otherwise, the second half of the branch of the selection operator is used to apply the editing including the declaration of the Mode type variable to the added new program piece. In such classification, the branch of the selection operator is exponentially increased in a case where the number of code pieces for which it is necessary to determine whether or not to add a variable according to the presence or absence of the definition of the variable is increased. Since two patterns of presence and absence are conceivable for each of such cord pieces, branches are formed in a power of at least two.

SmPL with many branches increases a possibility that an error is embedded in specification of the editing content. There is also a problem that the expression of the editing content is hardly intuitive. In a rewriting process of a program by using SmPL having many branches, there is also a problem that an amount of computation increases because backtracking of text matching frequently occurs in determination of a branch destination to be applied.

The present invention has been made in view of the above circumstances, and an object thereof is to improve efficiency regarding rewriting of a program.

### Solution to Problem

Therefore, in order to solve the above problem, a computer executes an input procedure of inputting a patch including an operator not defined in SmPL and having a variable name id for which a default value is specified, a type T of id, and an id default value t as arguments, and a description using SmPL, and a rewrite target program; and a generation procedure of generating a patch indicating, by using SmPL, that a variable declaration statement for substituting a computation result of t into the T-type variable id is added to the rewrite target program when the T-type variable is not defined in the rewrite target program, and generating a patch in which id in the description is replaced with the variable when the T-type variable is defined in the rewrite target program.

### Advantageous Effects of Invention

The efficiency related to rewriting of a program can be improved.

### BRIEF DESCRIPTION OF DRAWINGS

FIG. 1 is a diagram illustrating an example of SmPL by using a meta-variable v.

FIG. 2 is a diagram illustrating an example by using a selection operator (a|b).

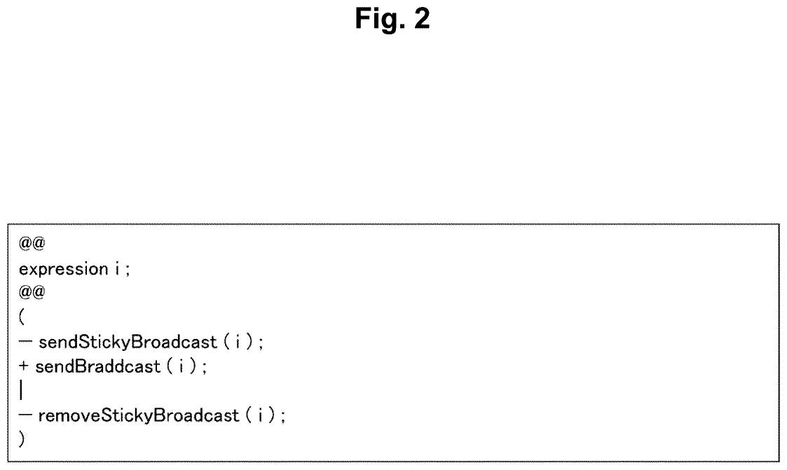

FIG. 3 is a diagram illustrating an example of a rewrite target program before SmPL is applied.

FIG. 4 is a diagram illustrating an example of a rewrite target program after SmPL is applied.

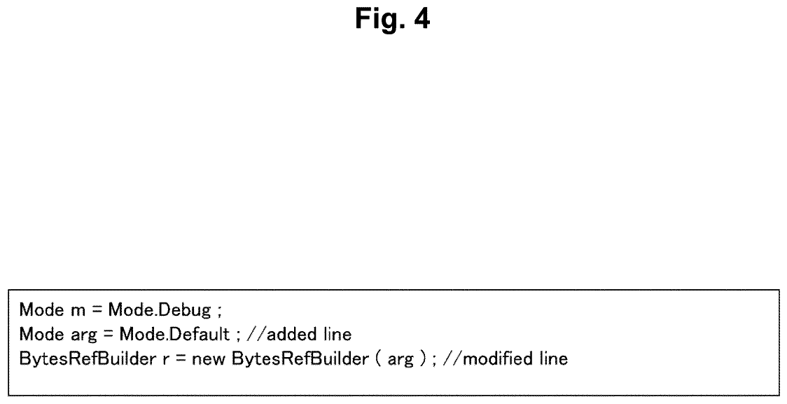

FIG. 5 is a diagram illustrating an example in which FIG. 1 is rewritten by using the selection operator.

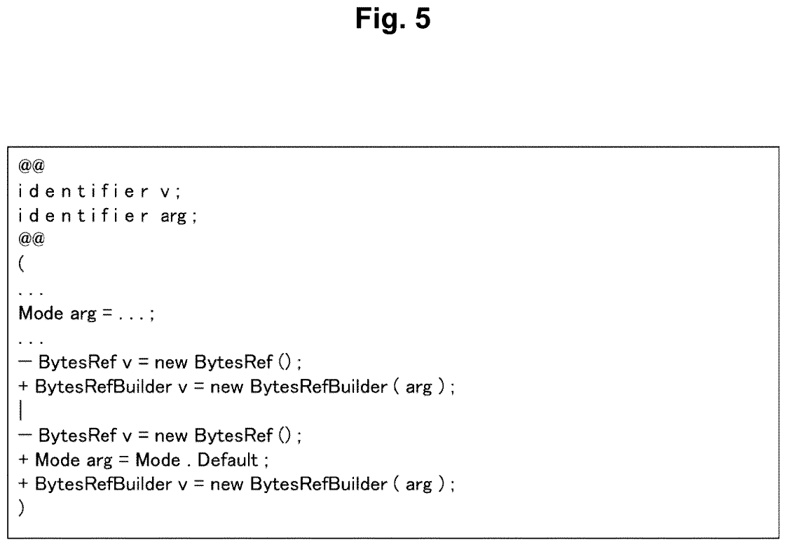

FIG. 6 is a diagram for describing a flow of a program rewriting process in the present embodiment.

FIG. 7 is a diagram illustrating an example in which rewriting in FIG. 1 is described by using a default value specifier.

FIG. 8 is a diagram illustrating a conversion result of FIG. 7 when a rewrite target program is the program illustrated in FIG. 3.

FIG. 9 is a diagram illustrating a hardware configuration example of a patch generation apparatus 10 according to the embodiment of the present invention.

FIG. 10 is a diagram illustrating a functional configuration example of the patch generation apparatus 10 according to the embodiment of the present invention.

FIG. 11 is a flowchart for describing an example of a processing procedure executed by the patch generation apparatus 10.

FIG. 12 is a flowchart for describing an example of a processing procedure of a process of matching P by using SmPL⁺⁷.

FIG. 13 is a flowchart for describing an example of a processing procedure of a process of searching for a variable declaration of the same type as a variable of Δᵢ.

### DESCRIPTION OF EMBODIMENTS

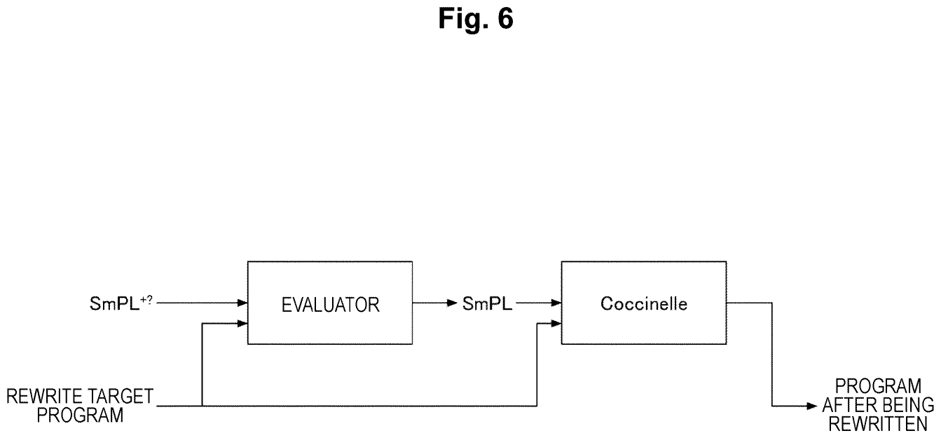

Hereinafter, embodiments of the present invention will be described with reference to the drawings. FIG. 6 is a diagram for describing a flow of a program rewriting process in the present embodiment.

The present embodiment discloses a default value specifier for briefly describing code editing that changes whether or not a code piece is added depending on whether or not a specific variable definition exists in a rewrite target program, and an evaluator thereof. The default value specifier is assumed to be used as a type of operator in a code editing definition using SmPL. The code editing definition using SmPL including default value specifier will be referred to as SmPL^{+?}. The evaluator generates SmPL (patch using SmPL) corresponding to the context of the rewrite target program when SmPL^{+?} and a rewrite target program are input. The generated SmPL can be applied to the rewrite target program by using Coccinelle to rewrite a code.

### [Default Value Specifier]

The default value specifier is a ternary operator using a variable name id for which a default value is specified, a type T thereof, and a default value t as arguments. The syntax of the default value specifier is given by “+^{?} id=t;” and can be read non-formally as “If the T-type variable is not defined in the rewrite target program, a variable declaration statement for substituting a computation result of t into the T-type variable id is added to the rewrite target program, and if defined, the variable is used as a replacement of id.”.

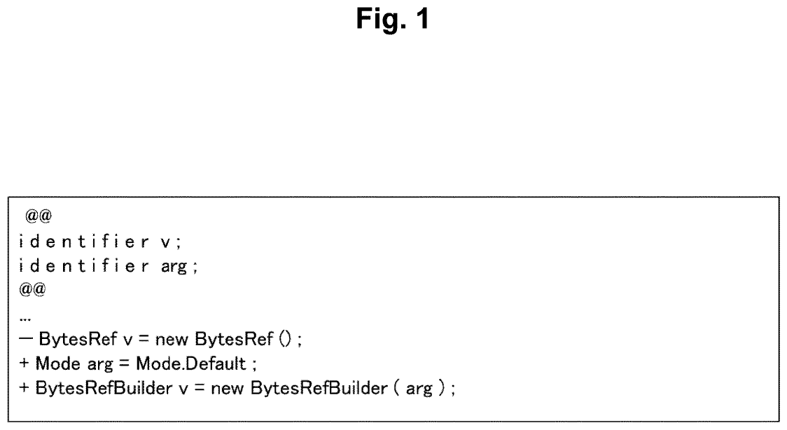

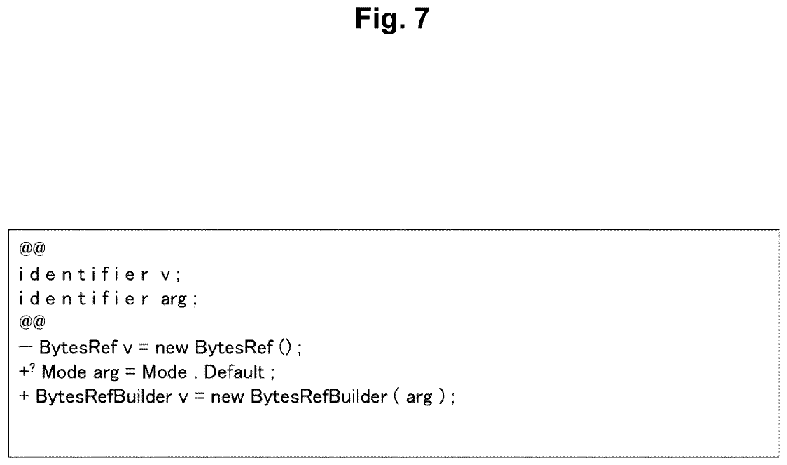

The default value specifier is used during code editing definition using SmPL. For example, code editing of adding the variable declaration statement of the Mode type variable arg in FIG. 1 only when the variable declaration statement does not exist in the rewrite target program can be briefly described by using the default value specifier as illustrated in FIG. 7.

### [Evaluator of Default Value Specifier]

The evaluator of the default value specifier receives SmPL^{+?} (patch using SmPL^{+?}) and a rewrite target program and converts the default value specifier in SmPL^{+?} into an SmPL statement. In this case, the evaluator does not rewrite the rewrite target program at all. The rewrite target program is used only to check the condition “if a T-type variable is not defined in the rewrite target program” in an editing rule represented by the default value specifier.

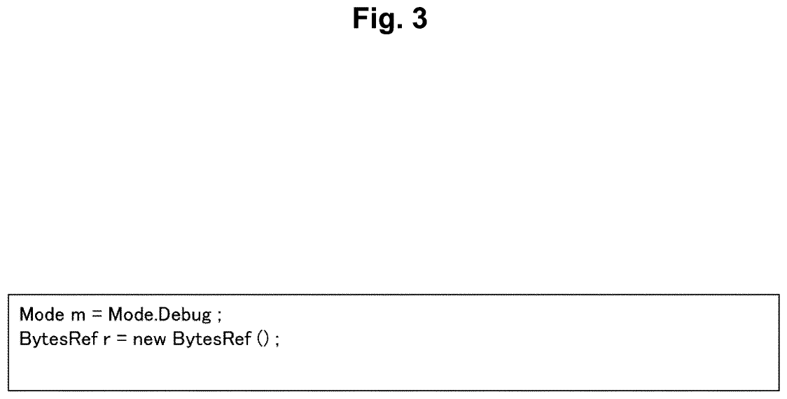

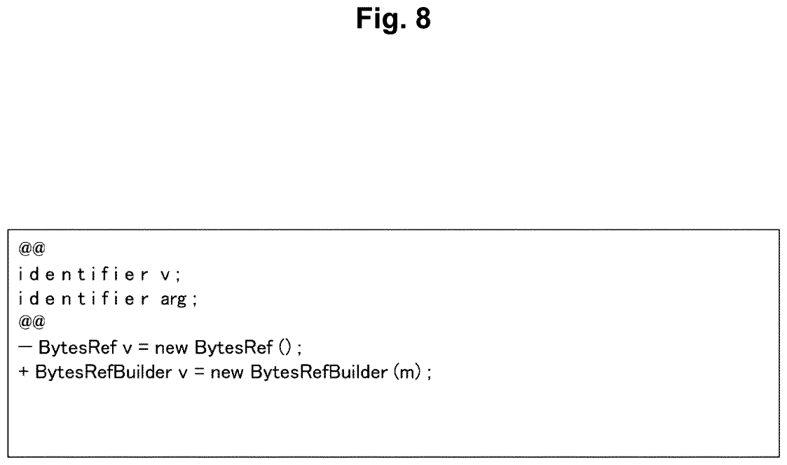

For example, when the rewrite target program is the program illustrated in FIG. 3, a result of conversion of SmPL^{+?} in FIG. 7 into SmPL by the evaluator is as illustrated in FIG. 8.

In FIG. 3, the definition of m is included as the Mode type variable, and thus Mode arg=Mode.Default; is not added. From this, it is understood that arg can be replaced with m, and thus the argument of BytesRefbuilder is rewritten from arg to m.

Note that, if the rewrite target program does not include the definition of m as the Mode type variable, the evaluator generates SmPL in which the default value specifier (+^{?} Mode arg=Mode.Default;) in SmPL^{+?} in FIG. 7 is replaced with an operator (+Mode arg=Mode.Default;) not including “?”.

### [Patch Generation Apparatus 10]

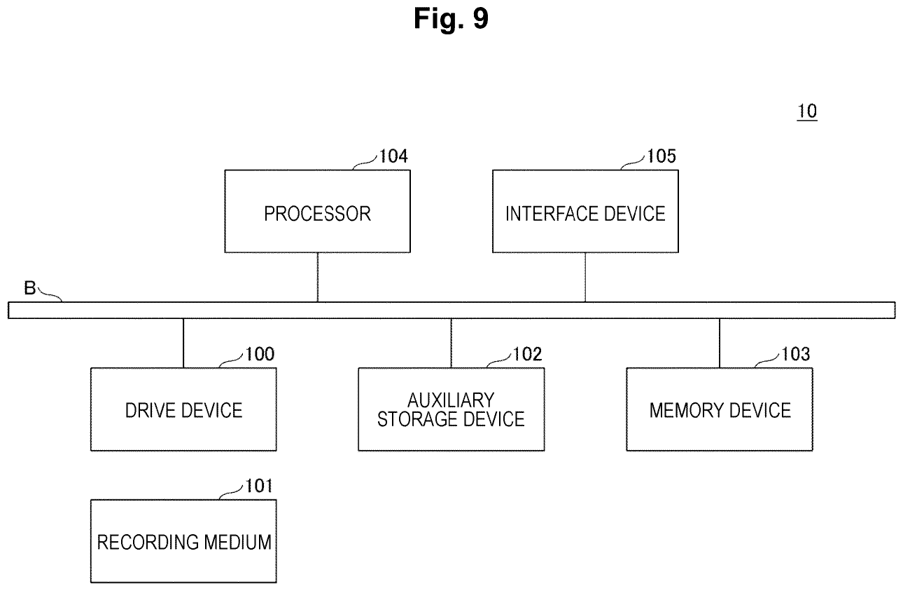

The patch generation apparatus 10 functioning as the evaluator will be described. FIG. 9 is a diagram illustrating a hardware configuration example of the patch generation apparatus 10 according to the embodiment of the present invention. The patch generation apparatus 10 in FIG. 9 includes a drive device 100, an auxiliary storage device 102, a memory device 103, a processor 104, an interface device 105, and the like connected to each other via a bus B.

A program for realizing processing in the patch generation apparatus 10 is provided by a recording medium 101 such as a CD-ROM. When the recording medium 101 storing the program is set in the drive device 100, the program is installed on the auxiliary storage device 102 from the recording medium 101 via the drive device 100. Here, the program is not necessarily installed from the recording medium 101 and may be downloaded from another computer via a network. The auxiliary storage device 102 stores the installed program and also stores required files, data, and the like.

In a case where an instruction to start the program is received, the memory device 103 reads the program from the auxiliary storage device 102 and stores the program. The processor 104 is a CPU or a graphics processing unit (GPU), or a CPU and a GPU, and executes a function related to the patch generation apparatus 10 according to the program stored in the memory device 103. The interface device 105 is used as an interface for connection to a network.

Note that the evaluator is realized by a program installed in the patch generation apparatus 10 causing the processor 104 to execute processes.

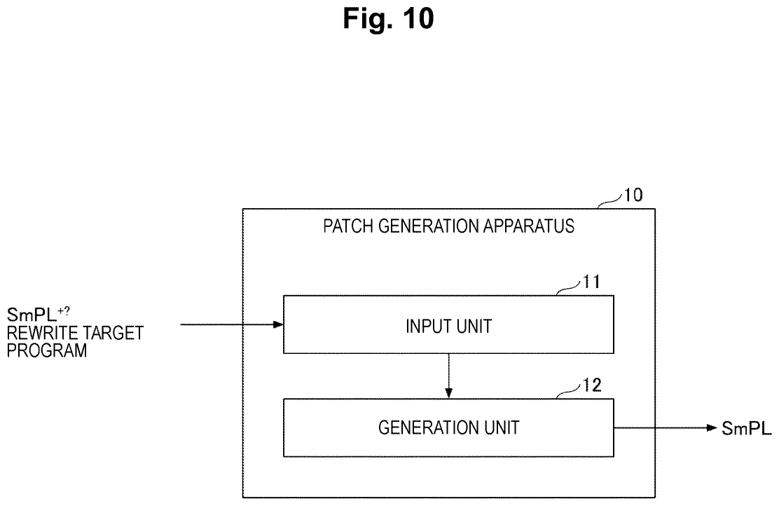

FIG. 10 is a diagram illustrating a functional configuration example of the patch generation apparatus 10 according to the embodiment of the present invention. In FIG. 10, the patch generation apparatus 10 includes an input unit 11 and a generation unit 12. That is, the input unit 11 and the generation unit 12 configure an evaluator. These units are realized by one or more programs installed in the patch generation apparatus 10 causing the processor 104 to execute processes. Note that the input unit and the generation unit configure an evaluator.

The input unit 11 inputs a patch (SmPL^{+?}) including a default value specifier that is an operator not defined in SmPL and has a variable name id for which a default value is specified, a type T of id, and an id default value t as arguments, and a description (referred to as a “description X”) using SmPL, and a rewrite target program.

When the T-type variable is not defined in the rewrite target program, the generation unit 12 generates a patch indicating, by using SmPL, that a variable declaration statement for substituting a computation result of t into the T-type variable id is added to the rewrite target program. Specifically, in this case, the generation unit 12 generates a patch in which the default value specifier is replaced with a description indicating, by using SmPL, that a variable declaration statement for substituting the computation result of t into the T-type variable id is added to the rewrite target program.

On the other hand, if the T-type variable is defined in the rewrite target program, the generation unit 12 generates a patch in which the id in the description X is replaced with the variable.

Before describing a processing procedure executed by the patch generation apparatus 10, definition of a data structure necessary for understanding the processing procedure will be described.

### [Rewrite Target Program]

$$[ Math . 1 ]$$

$$P ∈ Rewrite target program \text{::} = {G}_{1} {G}_{2} … {G}_{n}$$

$$G ∈ Grand terms \text{::} = op ( {G}_{1} , {G}_{2} , … , {G}_{k} ) \vert var ( {G}_{id} , {G}_{type} , G )$$

The rewrite target program is a column of Grand terms. Grand terms is a tree structure constructed with an operator op or var. op represents an operator having k arguments (taking k arguments). A leaf is represented as an operator having 0 arguments (taking 0 arguments (that is, no argument is taken)). var is a Grand term representing a declaration of a variable with substitution, and takes G_{id}, G_{type}, and G as arguments. G_{id}, G_{type}, and G respectively represent a variable name, a type name of the variable, and a Grand term to be substituted. In order to describe the default value specifier of the present embodiment, var is treated as an operator different from op.

### [SmPL]

$$[ Math . 2 ]$$

$$S ∈ Sequences \text{::} = E S \vert ε \vert ∃ x . S$$

$$E ∈ Elements \text{::} = D \vert ( S \vert S ) \vert T \vert + T \vert - T \vert ∃ x . E$$

$$T ∈ Terms \text{::} = G \vert ∃ x . T$$

$$D ∈ Dots \text{::} = … \vert D when != S$$

Here, G in the definition of Terms refers to Grand terms. For a detailed description including other operators and symbols, refer to the descriptions of Non Patent Literatures 1 and 2 that provide a formal definition of SmPL.

### [SmPL^{+?}]

A default value specifier is added to Elements of SmPL.

$$[ Math . 3 ]$$

$$S ∈ Sequences \text{::} = E S \vert ε \vert ∃ x . S$$

$$E ∈ Elements \text{::} = D \vert ( S \vert S ) \vert T \vert + T \vert - T \vert ∃ x . E \vert Δ$$

$$Δ ∈ Default \text{::} = {+}^{?} var ( {G}_{id} , {G}_{type} , T )$$

$$T ∈ Terms \text{::} = G \vert ∃ x . T$$

$$D ∈ Dots \text{::} = … \vert D when != S$$

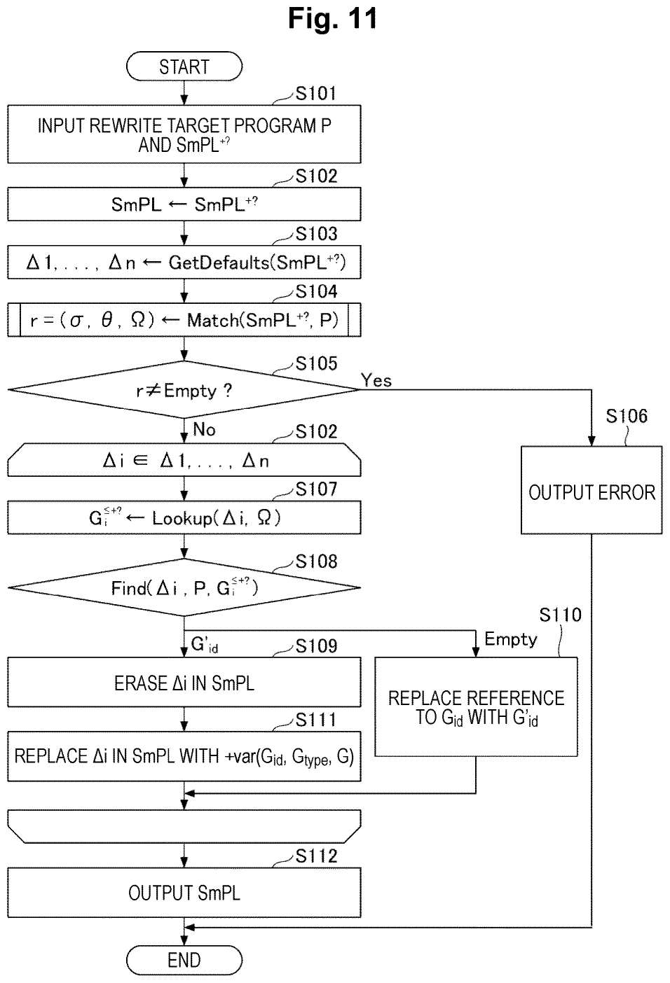

Hereinafter, a processing procedure executed by the patch generation apparatus 10 will be described. FIG. 11 is a flowchart for describing an example of a processing procedure executed by the patch generation apparatus 10.

In step S101, the input unit 11 inputs the rewrite target program P and SmPL^{+?}. SmPL^{+?} is SmPL including a default value specifier. SmPL is a patch in which the rewriting content of the rewrite target program P is described by SmPL.

Subsequently, the generation unit 12 substitutes the input SmPL^{+?} into SmPL as an initial value of the output (S102).

Subsequently, the generation unit 12 acquires default value specifiers Δ₁, . . . , Δₙ from the inside of SmPL^{+?} (S103).

Subsequently, the generation unit 12 matches P with SmPL^{+?} and substitutes a result thereof into r (S104). In a case where the matching is successful, a triplet of the Grand term σ of P, the mapping θ from the meta-variable in SmPL to the Grand terms of P, and the witness Ω is obtained as a value of r. In a case where the matching fails, Empty is obtained as a value of r.

Subsequently, the generation unit 12 determines whether the result of the matching is empty (Empty) (S105). In a case where the result of the matching is empty (Empty) (that is, in a case where the matching fails,) (Yes in S105), the generation unit 12 outputs an error (S106) and ends the process.

In a case where the result of the matching is not empty (Empty) (No in S105), the generation unit 12 executes a loop process including steps S107 to S111 for each Δᵢ from Δ₁ to Δₙ.

In step S107, the generation unit 12 acquires a Grand term in P that an Element immediately before Δᵢ matches from the matching result in step S104.

Δᵢ is an Element of SmPL^{+?}, and thus the following is established.

$$S m P {L}^{+ ?} = {E}_{1} … Δ 4 … ε$$

In this case, “Element immediately before Δᵢ” is defined as an Element other than the first +T, −T, and Δ when SmPL^{+?} is scanned from Δᵢ toward E₁, and is set as E\hat{ }. However, in a case where E\hat{ } does not exist, a final result of step S107 (lookup) is Empty.

The witness Ω has the meta-variable in SmPL and the mapping θ of Grand terms of P as elements. Since the meta-variable in SmPL necessarily includes a meta-variable associated with Elements of SmPL on a one-to-one basis, a “Grand term in P that an Element immediately before Δᵢ matches” can be acquired by referring to a Grand term in P in which θ maps to the meta-variable associated with E\hat{ }.

Subsequently, the generation unit 12 searches for a variable declaration of the same type as that of the variable of Δᵢ (S108).

In a case where a variable declaration G′_{id} of the same type as that of the variable of Δᵢ is found, the generation unit 12 erases Δᵢ (where Δᵢ=^{+?}var(G_{id}, G_{type}, G)) in SmPL (S109). Subsequently, the generation unit 12 replaces the reference to G_{id} in SmPL with G′_{id} (S110).

On the other hand, in a case where the variable declaration G′_{id} of the same type as that of the variable of Δᵢ is not found, the generation unit 12 replaces Δᵢ (where Δᵢ=^{+?}var(G_{id}, G_{type}, G)) in SmPL with +var(G_{id}, G_{type}, G) (S111).

When the loop process is ended, the generation unit 12 outputs SmPL (S112).

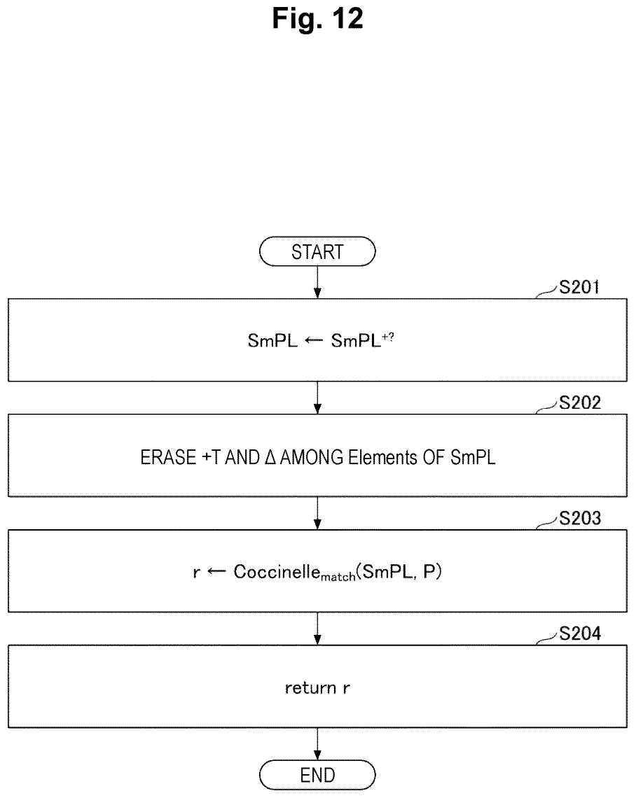

Next, details of step S104 will be described. FIG. 12 is a flowchart for describing an example of a processing procedure of the process of matching P with SmPL^{+?}. Inputs in the processing procedure in FIG. 12 are SmPL^{+?} and P in step S104 in FIG. 11.

In step S201, the generation unit 12 substitutes SmPL^{+?} into SmPL. Note that SmPL here is a valid local variable in FIG. 12, and is a variable different from SmPL in FIG. 11.

Subsequently, the generation unit 12 erases +T and Δ among the Elements of SmPL (S202).

Subsequently, the generation unit 12 substitutes a result of Coccinelle_{match} (SmPL, P) into r (S203). The processing of Coccinelle_{match} is executed by using a program matching algorithm of Coccinelle (CTL-VW (Non Patent Literature 1) model examination algorithm). The processing of Coccinelle_{match} returns a triplet of the Grand term σ of P, the mapping θ from the meta-variable in SmPL to Grand terms of P, and the witness Ω in a case where program matching is successful, and returns Empty in a case where program matching fails. However, the witness Ω is a triplet of the Grand term σ of P, the mapping θ from the meta-variable in SmPL to Grand terms of P, and the witness. The witness can be said to be a value having a recursive structure. The meta-variable in SmPL always includes meta-variables associated one-to-one with Elements of SmPL.

Subsequently, the generation unit 12 returns r (S204).

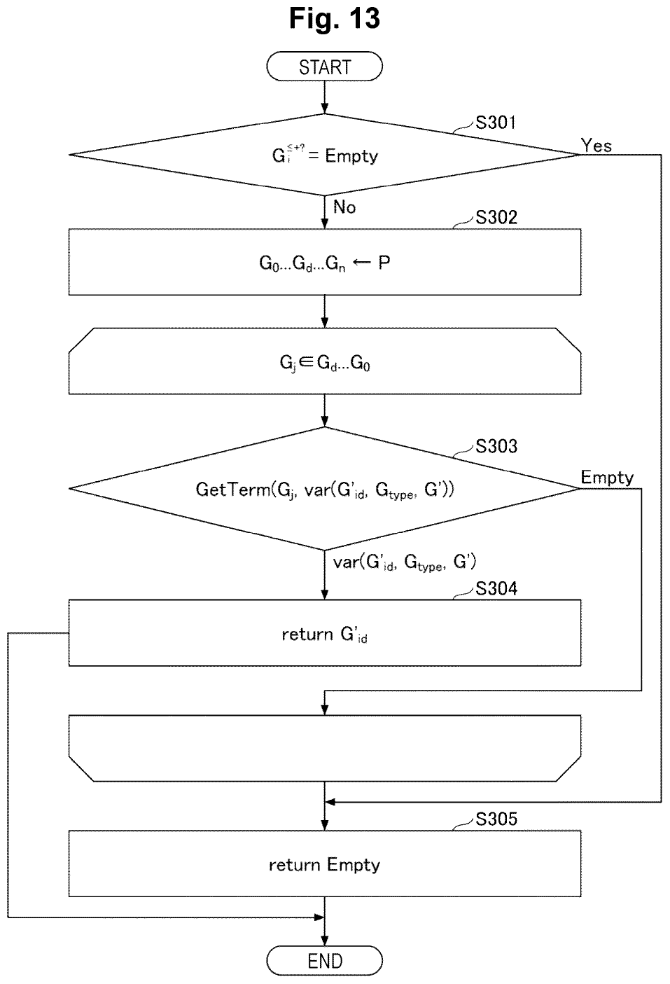

Next, step S108 in FIG. 11 will be described. FIG. 13 is a flowchart for describing an example of a processing procedure of a process of searching for a variable declaration of the same type as that of the variable of Δᵢ. Inputs in the processing procedure in FIG. 13 are the default value specifier Δᵢ (where Δᵢ=^{+?}var(G_{id}, G_{type}, G)), the rewrite target program P, and the Grand term as expressed in the following expression in step S108 in FIG. 11.

$$[ Math . 4 ]$$

$${G}_{i}^{\leq + ?}$$

In a case where a result of the following expression is Empty (Yes in S301),

$$[ Math . 5 ]$$

$${G}_{i}^{\leq + ?}$$

the generation unit 12 returns Empty (S305).

In a case where a result of the following expression is not Empty (No in S301),

$$[ Math . 6 ]$$

$${G}_{i}^{\leq + ?}$$

the generation unit 12 divides P into G₀ . . . G_{d} . . . Gₙ (S306). Here 0≤d≤n, and G_{d} is a Grand term including the following expression as a subtree.

$$[ Math . 7 ]$$

$${G}_{i}^{\leq + ?}$$

Subsequently, the generation unit 12 executes a loop process including steps S303 and S304 for each Gⱼ in order from G_{d} to G₀. That is, the rewrite target program P is scanned in the reverse order.

In step S303, the generation unit 12 finds a G_{type}-type variable definition (var(G′_{id}, G_{type}, G′)) from the subtree of Gⱼ. In a case where the corresponding variable definition (var(G′_{id}, G_{type}, G′)) can be found, the generation unit 12 returns G′_{id} (S304). In a case where the corresponding variable definition cannot be found, the generation unit 12 continues the loop process.

When the loop process is ended (that is, in a case where the G_{type}-type variable definitions (var(G′_{id}, G_{type}, G′)) cannot be found from the subtree of Gⱼ for all Gⱼ), the generation unit 12 returns Empty (S305).

The reason for scanning the rewrite target program P in the reverse order is to preferentially use a closest location to a location where a default value needs to be specified in a case where a plurality of G_{type}-type variable definitions can be found in searching the rewrite target program P for G_{type}-type variable definitions.

As described above, according to the present embodiment, code editing depending on the presence or absence of a variable definition in a rewrite target program can be simply described by using SmPL^{+?} including a default value specifier. Therefore, the ease of description and interpretability of such code editing can be improved. As a result, it is possible to acquire SmPL capable of performing the above-described code editing on a given rewrite target program with a small amount of computation, and it is possible to improve the efficiency related to rewriting of a program.

Although the embodiment of the present invention has been described in detail above, the present invention is not limited to such a specific embodiment, and various modifications and changes can be made within the scope of the concept of the present invention disclosed in the claims.

### REFERENCE SIGNS LIST

10 Patch generation apparatus
11 Input unit
12 Generation unit
100 Drive device
101 Recording medium
102 Auxiliary storage device
103 Memory device
104 Processor
105 Interface device
B Bus

1. A patch generation method of causing a computer to execute:
inputting a patch including an operator not defined in SmPL and having a variable name id for which a default value is specified, a type T of id, and an id default value t as arguments, and a description using SmPL, and a rewrite target program; and
generating a patch indicating, by using SmPL, that a variable declaration statement for substituting a computation result of t into the T-type variable id is added to the rewrite target program when the T-type variable is not defined in the rewrite target program, and generating a patch in which id in the description is replaced with the variable when the T-type variable is defined in the rewrite target program.

2. The patch generation method according to claim 1, wherein
in the generating of the patch, when the T-type variable is not defined in the rewrite target program, a patch in which the operator is replaced with a description indicating, by using SmPL, that a variable declaration statement for substituting a computation result of t into the T-type variable id is added to the rewrite target program is generated.

3. A patch generation apparatus comprising:
a processor; and
a memory storing program instructions that cause the processor to:
input a patch including an operator not defined in SmPL and having a variable name id for which a default value is specified, a type T of id, and an id default value t as arguments, and a description using SmPL, and a rewrite target program; and
generate a patch indicating, by using SmPL, that a variable declaration statement for substituting a computation result of t into the T-type variable id is added to the rewrite target program when the T-type variable is not defined in the rewrite target program, and generating a patch in which id in the description is replaced with the variable when the T-type variable is defined in the rewrite target program.

4. The patch generation apparatus according to claim 3, wherein
the program instructions cause the processor to, when the T-type variable is not defined in the rewrite target program, generate a patch in which the operator is replaced with a description indicating, by using SmPL, that a variable declaration statement for substituting a computation result of t into the T-type variable id is added to the rewrite target program.

5. A non-transitory computer-readable recording medium having stored therein a program causing a computer to execute the patch generation method according to claim 1.
